(19) United States
(12) Patent Application Publication
(10) Pub. No.: US 2007/0001360 A1
(43) Pub. Date: Jan. 4, 2007

(54) Clamp device

(76) Inventor: Yosuke Haruna, Kobe-shi (JP)

Correspondence Address: BACON & THOMAS, PLLC, 625 SLATERS LANE, FOURTH FLOOR, ALEXANDRIA, VA, 22314, US

(21) Appl. No.: 10/567,562

(22) PCT Filed: Jul. 16, 2004
(86) PCT No.: PCT/JP04/10196

§ 371 Date: Feb. 8, 2006

(30) Foreign Application Priority Data
Aug. 8, 2003 (JP) 2003-290377

(51) Int. Cl. B23Q 3/00

(52) U.S. Cl. 269/309

(57) ABSTRACT

A plug portion (27) is projected from a reference member (2) so as to be inserted into a hole (5) opened in a movable member (3). A fitting surface (16) allowed to fit to an inner peripheral surface of the hole (5) is formed on an outer peripheral surface of the plug portion (27). In the fitting surface (16) are opened desirably a plurality of fluid flow holes (38), and when the fitting surface (16) comes into close contact with the inner peripheral surface of the hole (5), the fluid flow holes (38) are closed by the inner peripheral surface of the hole (5). Pressurized fluid supplied to a fluid port (39) is jetted from the fluid flow holes (38).

### TECHNICAL FIELD

The present invention relates to a clamping apparatus, more particularly, relating to an apparatus for clamping a movable member such as a work pallet on a reference member such as a table of a machine tool.

### BACKGROUND ART

This kind of clamping apparatus is described in Patent Document 1 for example. As illustrated in FIG. 1 thereof, the clamping apparatus disclosed in Patent Document 1 is constituted in such a way that a plurality of work reference pieces and movable clamping claws are attached to a jig, the work reference pieces are provided with a stationary clamp reference surface, and a worked surface of a workpiece is allowed to come into close contact with and be supported on the stationary clamp reference surface. The jig is fastened on the bed of a machine tool. A jet hole is drilled at the center of the stationary clamp reference surface on an upper end of each work reference piece, and the jet hole is communicatively connected to a compressed air source.

With this structure, it is possible to sweep away swarf produced during machine work by jet flow from the jet hole, thereby, when the workpiece is clamped, the swarf is prevented from being caught between the stationary clamp reference surface and the worked surface of the workpiece.
Patent Document 1: Jpn. Unexamined Patent Publication No. S54-17580

### SUMMARY OF THE INVENTION

Problems to be Solved by the Invention

However, in the above-mentioned structure of Patent Document 1, it is impossible to detect whether a proper clamping is performed or not, namely, a clamping such that the worked surface of the workpiece completely comes into close contact with the stationary clamp reference surface. For example, even when foreign matter such as swarf is not completely removed by the jet flow from the jet hole, but caught between the stationary clamp reference surface and the worked surface to develop a gap, the gap cannot be detected.

As a result, machine work may continue without interruption of the process even when the above-described abnormal clamping occurs. Therefore, machining accuracy is reduced or troubles is found such as breakage of tools in an extreme case.

Means for Solving the Problems and Effects

The problems to be solved by the present invention are described above, next, an explanation is made for means for solving these problems and effects.

(1) The clamping apparatus according to the present invention is constituted in such a way that, as illustrated in FIG. 1(a) through FIG. 8 respectively for example, a plug portion 27 is projected from a reference member 2 so as to be inserted into a hole 5 opened in a movable member 3, a fitting surface 16 allowed to fit to an inner peripheral surface of the hole 5 is formed on an outer peripheral surface of the plug portion 27, a fluid flow hole 38 is opened in the fitting surface 16, and when the fitting surface 16 comes into close contact with the inner peripheral surface of the hole 5, the fluid flow hole 38 is closed by the inner peripheral surface of the hole 5.

Herein, the “clamping apparatus” refers to an apparatus capable of attaching and detaching the movable member 3 to and from the reference member 2, and also restricting at least one axial movement of the movable member 3 in relation to the reference member 2.

With this structure, it is possible to judge whether or not the fitting surface 16 comes into close contact with the inner peripheral surface of the hole 5 by detecting the pressure at the fluid flow hole 38. In such a case that foreign matter such as swarf is caught between the fitting surface 16 and the inner peripheral surface of the hole 5 to develop a gap, it is possible to properly detect the gap, thereby a structure suitable for an automatic control is provided. Particularly, in a type of clamping apparatus in which the outer peripheral surface (fitting surface 16) of the plug portion 27 comes into close contact with the inner peripheral surface of the hole 5 to perform clamping, unlike the above-described structure disclosed in Patent Document 1, it is extremely difficult to visually confirm whether an appropriate clamping is performed or not because the plug portion 27 is concealed inside the hole 5. However, the present structure makes it possible to detect an abnormal clamping easily and reliably.

(2) Herein, it is preferable that pressurized fluid is jetted from the fluid flow hole 38. This structure is advantageous in that, by supplying the pressurized fluid at a high pressure to the fluid flow hole 38, even a slight gap between the fitting surface 16 and the inner peripheral surface of the hole 5 can be reliably detected so as to judge an abnormal clamping.

(3) Further, it is desirable that the pressurized fluid is used also for cleaning. With this structure, it is possible to remove foreign matter adhered on the fitting surface 16 and/or the inner peripheral surface of the hole 5 by the jet fluid from the fluid flow hole 38. Foreign matter which may enter the fluid flow hole 38 can also be blown out and removed by the jet fluid to improve the reliability of detecting an abnormal clamping.

(4) Herein, it is desirable that compressed air is employed as the pressurized fluid. In this case, a mechanically simple structure for detecting an abnormal clamping can be employed.

(5) However, it is also possible that fluid is sucked into the fluid flow hole 38. This structure is preferable in a case where dust-free conditions are needed, for example, a clean room.

(6) Herein, as illustrated in FIG. 3(b) for example, it is preferable that the fluid flow holes 38 are provided in plurality. With this structure, it is possible to detect an abnormal clamping, even when one of the fluid flow holes 38 is undesirably clogged with foreign matter such as swarf and the one gets unable to detect an abnormal clamping, however as long as all the plurality of the fluid flow holes 38 are not clogged. Therefore, it is possible to improve the reliability of detecting an abnormal clamping.

(7) Further, as illustrated in FIG. 3(b) for example, it is desirable that the fluid flow holes 38 are provided circumferentially in plurality. With this structure, it is possible to properly detect a state illustrated in FIG. 4 for example, that is, where although the fitting surface 16 does not completely come into close contact with the inner peripheral surface of the hole 5, one of the jet holes 38 is accidentally closed by the inner peripheral surface of the hole 5 due to misalignment between the axis of the plug portion 27 and the axis of the hole 5 as an abnormal clamping. In short, with this structure, it is possible to properly detect the state illustrated in FIG. 4 as an abnormal clamping.

(8) Herein, as illustrated in FIG. 3(a) and FIG. 3(b) for example, it is desirable that a housing 9 provided in the reference member 2 is provided with a fluid port 39 for supplying pressurized fluid or discharging fluid, and the fluid port 39 is branched via a passage 42 from the fluid port 39 and is communicatively connected to each of the plurality of fluid flow holes 38. With this structure, it is possible to properly detect an abnormal clamping by checking the pressure at the fluid port 39 not only in a case where all of the plurality of fluid flow hole 38 are not closed but also in a case where only some of them are not closed. Further, a mechanically simple fluid passage can be obtained because the fluid port 39 is branched at the passage 42 and communicatively connected to each of the fluid flow holes 38.

(9) The present invention is constituted in such a way that, as illustrated in FIG. 1(a) and FIG. 1(b) for example, a central pillar 12 is projected from a reference member 2 so as to be inserted into a hole 5 opened in a movable member 3, the central pillar 12 is provided with an inclined outer surface 13 that gets closer to the axis toward a leading end of the projecting direction, an annular intermediate member 15 in which at least a part of the circumferential direction is allowed to deform in both the expanding direction and contracting direction is arranged at the outside of the inclined outer surface 13, the intermediate member 15 is provided with a straight outer surface 16 allowed to fit to an inner peripheral surface of the hole 5 and with an inclined inner surface 17 facing the inclined outer surface 13, a pull member 21 is inserted into the central pillar 12 axially movably, and the pull member 21 is connected to the intermediate member 15, a lock means and a release means are provided in the reference member 2, the lock means moves the intermediate member 15 via the pull member 21 toward a base end for locking and the release means moves the intermediate member 15 via the pull member 21 toward the leading end for releasing, a fluid flow hole 38 is opened in the straight outer surface 16 of the intermediate member 15, and when the intermediate member 15 moves for locking and the straight outer surface 16 comes into close contact with the inner peripheral surface of the hole 5, the fluid flow hole 38 is closed by the inner peripheral surface of the hole 5.

With this structure, it is possible to judge whether or not the straight outer surface 16 of the intermediate member 15 comes into close contact with the inner peripheral surface of the hole 5 by checking the pressure at the fluid flow hole 38. Therefore, in such a case that foreign matter such as swarf is caught between the straight outer surface 16 of the intermediate member 15 and the inner peripheral surface of the hole 5 to develop a gap, it is possible to properly detect the gap, thereby a structure suitable for an automatic control can be obtained.

(10) Herein, as illustrated in FIG. 1(a) and FIG. 1(b) for example, it is preferable that a housing 9 provided in the reference member 2 is provided with a fluid port 39 for supplying pressurized fluid or discharging fluid, a fluid passage 40 is provided inside the housing 9 and the fluid passage 40 is connected to the fluid port 39, the fluid passage 40 is provided with a relay opening 41 in the inclined outer surface 13 of the central pillar 12, and the fluid flow hole 38 is provided so that one end is opened in the straight outer surface 16 and the other end is opened in the inclined inner surface 17 respectively, and the other end faces the relay opening 41. With this structure, it is possible to easily detect whether an abnormal clamping occurs or not by checking the pressure on the fluid port 39 side.

(11, 12) Herein, as illustrated in FIG. 3(b) for example, it is preferable that the fluid flow holes 38 are provided in plurality and particularly provided circumferentially in plurality. With these structures, it is possible to improve the reliability of detecting an abnormal clamping, as with the cases of (6) and (7).

(13) It is noted that, as illustrated in FIG. 3(b) for example, it is preferable that the fluid passage 40 is communicatively connected to a groove 42 formed in the circumferential direction in at least either the inclined outer surface 13 of the central pillar 12 or the inclined inner surface 17 of the intermediate member 15, and each of the openings of the fluid flow holes 38 on the inclined inner surface 17 side faces the groove 42. In this structure, a mechanically simple fluid passage can be obtained because the fluid passage 40 is branched at the groove 42 in the circumferential direction and communicatively connected to each of the fluid flow holes 38.

(14) As illustrated in FIG. 1(a) and FIG. 3(a) for example, it is also preferable that the pull member 21 is allowed to pull the movable member 3 toward the reference member 2 side. Thereby, a mechanically simple structure that can restrict the movement of the movable member 3 along the axis of the central pillar 12 can be obtained.

(15) The present invention is constituted in such a way that, as illustrated in FIG. 5(a) and FIG. 5(b) for example, a central pillar 12 is projected from a reference member 2 so as to be inserted into a hole 5 opened in a movable member 3, the central pillar 12 is provided with an inclined outer surface 13 that gets closer to the axis toward a leading end of the projection direction, a plurality of pressing members 43 that are radially movable are arranged at the outside of the inclined outer surface 13, and the pressing member 43 is provided with a straight outer surface 16 allowed to fit to an inner peripheral surface of the hole 5 and with an inclined inner surface 17 facing the inclined outer surface 13, a pull member 21 is inserted into the central pillar 12 axially movably, and the pull member 21 is connected to the pressing members 43, a lock means and a release means are provided in the reference member 2, the lock means moves the pressing members 43 via the pull member 21 toward a base end for locking, and the release means moves the pressing members 43 via the pull member 21 toward the leading end for releasing, a fluid flow hole 38 is opened in the straight outer surface 16 of the pressing member 43, and when the pressing member 43 moves for locking and the straight outer surface 16 comes into close contact with the inner peripheral surface of the hole 5, the fluid flow hole 38 is closed by the inner peripheral surface of the hole 5.

With this structure, it is possible to judge whether or not the straight outer surface 16 of the pressing member 43 comes into close contact with the inner peripheral surface of the hole 5 by checking the pressure at the fluid flow hole 38. Therefore, in such a case that foreign matter such as swarf is caught between the straight outer surface 16 of the pressing member 43 and the inner peripheral surface of the hole 5 to develop a gap, it is possible to properly detect the gap, thereby a structure suitable for an automatic control can be obtained.

(16) Herein, it is desirable that a housing 9 provided in the reference member 2 is provided with a fluid port 39 for supplying pressurized fluid or discharging fluid, a fluid passage 40 is provided inside the housing 9, and the fluid passage 40 is connected to the fluid port 39, the fluid passage 40 is provided with a relay opening 41 in the inclined outer surface 13 of the central pillar 12, and the fluid flow hole 38 is provided so that one end is opened in the straight outer surface 16 and the other end is opened in the inclined inner surface 17 respectively, and the other end faces the relay opening 41. With this structure, it is possible to easily detect whether an abnormal clamping occurs or not by checking the pressure on the fluid port 39 side.

(17, 18) Herein, as illustrated in FIG. 5(b) for example, it is preferable that the fluid flow holes 38 are provided in plurality and particularly provided circumferentially in plurality. With these structures, it is possible to improve the reliability of detecting an abnormal clamping, as with the cases of (6) and (7).

(19) As illustrated in FIG. 5(a) for example, it is also preferable that the pull member 21 is allowed to pull the movable member 3 toward the reference member 2 side. Thereby, a mechanically simple structure that can restrict the movement of the movable member 3 along the axis of the central pillar 12 can be obtained.

(20) The present invention is constituted in such a way that, as illustrated in FIG. 6(a) for example, a central pillar 12 is projected from a reference member 2 so as to be inserted into a hole 5 opened in a movable member 3, an inner sleeve 61 which is radially expandable and contractible is supported on the central pillar 12 movably along the axis of the central pillar 12, and a tapered outer surface 13 is formed on an outer peripheral surface of the inner sleeve 61, an outer sleeve 71 which is radially expandable and contractible is arranged at the outside of the inner sleeve 61, a tapered inner surface 17 allowed to make a tapering engagement with the tapered outer surface 13 is formed on an inner peripheral surface of the outer sleeve 71, a straight surface 16 allowed to fit to an inner peripheral surface of the hole 5 is formed on an outer peripheral surface of the outer sleeve 71, an advancing means 25 which presses the inner sleeve 61 in such a direction as to tighten the tapering engagement is provided, a fluid flow hole 38 is opened in the straight outer surface 16, and when the straight outer surface 16 comes into close contact with the inner peripheral surface of the hole 5, the fluid flow hole 38 is closed by the inner peripheral surface of the hole 5.

With this structure, it is possible to judge whether or not the straight outer surface 16 of the outer sleeve 71 comes into close contact with the inner peripheral surface of the hole 5 by checking the pressure at the fluid flow holes 38. Therefore, in such a case that foreign matter such as swarf is caught between the straight outer surface 16 of the outer sleeve 71 and the inner peripheral surface of the hole 5 to develop a gap, it is possible to properly detect the gap, thereby a structure suitable for an automatic control can be obtained.

(21) Herein, as illustrated in FIG. 6(a) for example, it is preferable that a housing 9 provided in the reference member 2 is provided with a fluid port 39 for supplying pressurized fluid or discharging fluid, a fluid passage 40 is provided inside the housing 9, and the fluid passage 40 is connected to the fluid port 39, the fluid passage 40 is provided with a relay opening 41 in an outer peripheral surface of the central pillar 12, and the fluid flow hole 38 is provided so that one end is opened in the straight outer surface 16 and the other end is opened in the tapered inner surface 17 respectively, and the other end is connected to the relay opening 41 via a communication hole 79 formed in the inner sleeve 61 in a penetrating manner. With this structure, it is possible to easily detect whether an abnormal clamping occurs or not by checking the pressure on the fluid port 39 side.

(22, 23) It is noted that, although not illustrated in the figures, it is preferable that the fluid flow holes 38 are provided in plurality and particularly provided circumferentially in plurality. With these structures, it is possible to improve the reliability of detecting an abnormal clamping, as with the cases of (6) and (7).

(24) Although not illustrated here either, it is preferable that the fluid passage 40 is communicatively connected to a groove formed in the circumferential direction in at least either the inclined outer surface 13 of the inner sleeve 61 or the inclined inner surface 17 of the outer sleeve 71, and each of the openings of the fluid flow holes 38 on the inclined inner surface 17 side faces the groove. In this structure, a mechanically simple fluid passage can be obtained because the fluid passage 40 is branched at the groove in the circumferential direction and communicatively connected to each of the fluid flow holes 38.

(25) Further, as illustrated in FIG. 6(a) for example, it is preferable that a pull member 21 is provided on the housing 9 provided in the reference member 2, and the pull member 21 is allowed to pull the movable member 3 toward the reference member 2 side. Thereby, a mechanically simple structure that can restrict the movement of the movable member 3 along the axis of the central pillar 12 can be obtained.

(26) The present invention is constituted in such a way that, as illustrated in FIG. 7(a) for example, a central pillar 12 is projected from a reference member 2 so as to be inserted into a hole 5 opened in a movable member 3, an intermediate member 15 which is radially expandable and contractible is supported on the central pillar 12 movably along the axis of the central pillar 12, a tapered fitting surface 16 is formed on an outer peripheral surface of the intermediate member 15, a tapered inner surface 17 allowed to make a tapering engagement with the tapered fitting surface 16 is formed on the hole 5, an advancing means 25 which presses the intermediate member 15 in such a direction as to tighten the tapering engagement is provided, and a fluid flow hole 38 is opened in the tapered fitting surface 16, and when the tapered fitting surface 16 comes into close contact with the tapered inner surface 17, the fluid flow hole 38 is closed by the tapered inner surface 17.

With this structure, it is possible to judge whether or not the tapered fitting surface 16 comes into close contact with the tapered inner surface 17 by checking the pressure at the fluid flow hole 38. Therefore, in such a case that foreign matter such as swarf is caught between the tapered fitting surface 16 and the tapered inner surface 17 to develop a gap, it is possible to properly detect the gap, thereby a structure suitable for an automatic control can be obtained.

(27) Herein, it is preferable that a housing 9 provided in the reference member 2 is provided with a fluid port 39 for supplying pressurized fluid or discharging fluid, a fluid passage 40 is provided inside the housing 9, and the fluid passage 40 is connected to the fluid port 39, the fluid passage 40 is provided with a relay opening 41 in an outer peripheral surface of the central pillar 12, the fluid flow hole 38 is provided so that one end is opened in the tapered fitting surface 16 and the other end is opened in an inner peripheral surface of the intermediate member 15 respectively, and the other end faces the relay opening 41. With this structure, it is possible to easily detect whether an abnormal clamping occurs or not by checking the pressure on the fluid port 39 side.

(28, 29) It is noted that, although not illustrated here, it is preferable that the fluid flow holes 38 are provided in plurality and particularly provided circumferentially in plurality. With these structures, it is possible to improve the reliability of detecting an abnormal clamping, as with the cases of (6) and (7).

(30) Although not illustrated here either, it is preferable that the fluid passage 40 is communicatively connected to a groove formed in the circumferential direction in at least either the inner peripheral surface of the intermediate member 15 or the outer peripheral surface of the central pillar 12, and each of the openings of the fluid flow hole 38 on the inner peripheral surface side of the intermediate member 15 faces the groove. In this structure, a mechanically simple fluid passage can be obtained because the fluid passage 40 is branched at the groove in the circumferential direction and communicatively connected to each of the fluid flow holes 38.

(31) Further, as illustrated in FIG. 7(a) for example, it is preferable that a pull member 21 is provided on the housing 9 provided in the reference member 2, and the pull member 21 is allowed to pull the movable member 3 toward the reference member 2 side. Thereby, a mechanically simple structure that can restrict the movement of the movable member 3 along the axis of the central pillar 12 can be obtained.

(32) The present invention is constituted in such a way that, as illustrated in FIG. 8 for example, a central pillar 12 is projected from a reference member 2 so as to be inserted into a hole 5 opened in a movable member 3, an intermediate member 15 which is radially expandable and contractible is supported on a support hole 92 of the movable member 3 movably along the axis of the support hole 92, a tapered inner surface 17 constituting the hole 5 is formed on an inner peripheral surface of the intermediate member 15, and a tapered fitting surface 16 allowed to make a tapering engagement with the tapered inner surface 17 is formed on the central pillar 12, an advancing means 25 which presses the intermediate member 15 in such a direction as to tighten the tapering engagement is provided, and a fluid flow hole 38 is opened in the tapered fitting surface 16, and when the tapered fitting surface 16 comes into close contact with the tapered inner surface 17, the fluid flow hole 38 is closed by the tapered inner surface 17.

With this structure, it is possible to judge whether or not the tapered fitting surface 16 comes into close contact with the tapered inner surface 17 by checking the pressure at the fluid flow holes 38. Therefore, in such a case that foreign matter such as swarf is caught between the tapered fitting surface 16 and the tapered inner surface 17 to develop a gap, it is possible to properly detect the gap, thereby a structure suitable for an automatic control can be obtained.

(33, 34) It is noted that, although not illustrated here, it is preferable that the fluid flow holes 38 are provided in plurality and particularly provided circumferentially in plurality. With these structure, it is possible to improve the reliability of detecting an abnormal clamping, as with the cases of (6) and (7).

(35) As illustrated in FIG. 8 for example, it is also preferable that a pull member 21 is provided on the housing 9 provided in the reference member 2, and the pull member 21 is allowed to pull the movable member 3 toward the reference member 2 side. Thereby, a mechanically simple structure that can restrict the movement of the movable member 3 along the axis of the central pillar 12 can be obtained.

### BRIEF DESCRIPTION OF THE DRAWINGS

FIG. 1(a) is an elevated cross-sectional view showing a released state of the clamping apparatus according to a first embodiment of the present invention;

FIG. 1(b) is a cross-sectional view indicated by the arrow b-b in FIG. 1(a);

FIG. 2(a) is an elevated cross-sectional view showing a locked state of the clamping apparatus;

FIG. 2(b) is a cross-sectional view indicated by the arrow b-b in FIG. 2(a);

FIG. 3(a) is an elevated cross-sectional view showing a released state of the clamping apparatus according to a second embodiment of the present invention;

FIG. 3(b) is a cross-sectional view indicated by the arrow b-b in FIG. 3(a);

FIG. 4 is a plain cross-sectional view of the clamping apparatus in which the axis of the plug portion is misaligned with the axis of the positioning hole and one of the jet holes is closed, and similar to FIG. 3(b);

FIG. 5(a) is an elevated cross-sectional view showing a released state of the clamping apparatus according to a third embodiment of the present invention;

FIG. 5(b) is a cross-sectional view indicated by the arrow b-b in FIG. 5(a);

FIG. 6(a) is an elevated cross-sectional view showing a locked state of the clamping apparatus according to a fourth embodiment of the present invention;

FIG. 6(b) is a cross-sectional view indicated by the arrow b-b in FIG. 6(a);

FIG. 7(a) is an elevated cross-sectional view showing a locked state of the clamping apparatus according to a fifth embodiment of the present invention;

FIG. 7(b) is a cross-sectional view indicated by the arrow b-b in FIG. 7(a); and

FIG. 8 is an elevated cross-sectional view showing a locked state of the clamping apparatus according to a sixth embodiment of the present invention, and similar to FIG. 7(a).

### EXPLANATION OF REFERENCES

2: base plate (reference member)
3: work pallet (movable member)
5: positioning hole (hole)
9: reference block (housing)
13: tapered outer surface (inclined outer surface)
15: intermediate member
16: fitting surface
17: tapered inner surface (inclined inner surface)
21: pull member
27: plug portion
38: jet hole (fluid flow hole)
39: air port (fluid port)
40: air passage (fluid passage)
41: relay opening
42: communication groove (groove, passage)

### BEST MODE FOR CARRYING OUT THE INVENTION

### First Embodiment

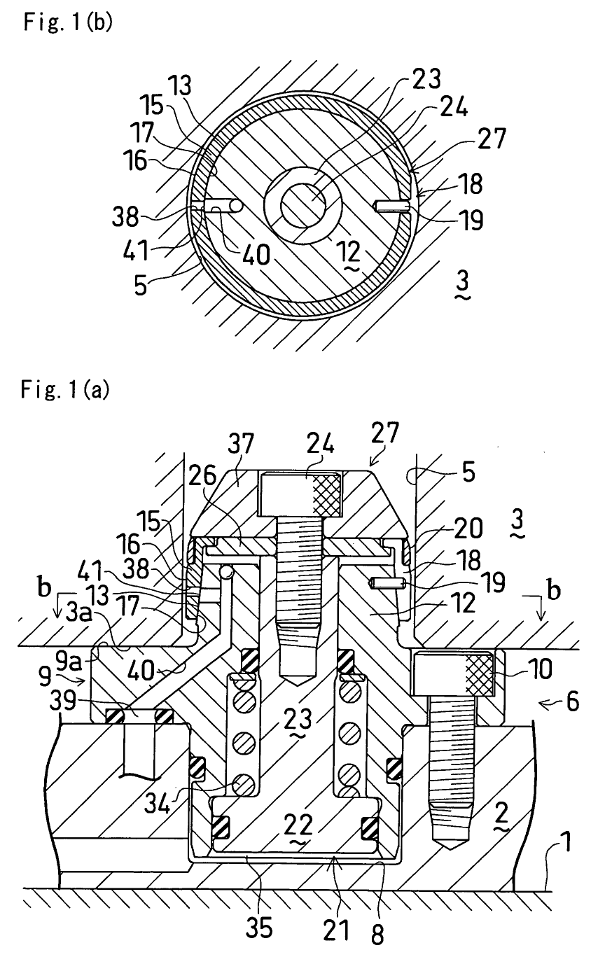

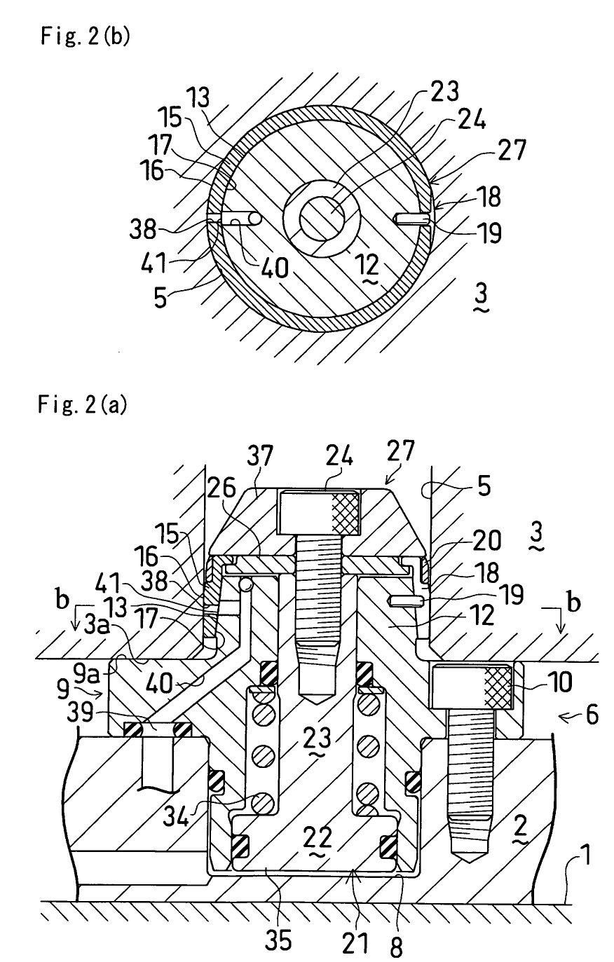

First, an explanation will be made for a first embodiment of the present invention by referring to FIG. 1(a) through FIG. 2(b)

As illustrated in FIG. 1(a), an automatic positioning apparatus (clamping apparatus) of the present embodiment is constituted in such a way that, a base plate 2 as a reference member is placed on a table 1 of a machine tool, and a supported surface 3a of a work pallet 3 as a movable member is received on a support surface 9a of a reference block 9 as a housing to be fixed on the base plate 2. The automatic positioning apparatus is also constituted in such a way that, when the supported surface 3a is received on the support surface 9a, the work pallet 3 is positioned in the horizontal direction with the work pallet 3 aligned in relation to the base plate 2.

On a lower surface of the work pallet 3 is formed the supported surface 3a, and in the supported surface 3a are opened circular positioning holes 5 machined precisely in plurality. And a plug means 6 is provided on the base plate 2 in correspondence to each of the positioning holes 5. It is noted that, here, only one set among a plurality of sets composed of both the positioning holes 5 and the plug means 6 is illustrated.

An explanation is made for the structure of the plug means 6. As illustrated in FIG. 1(a), an installation hole 8 is opened in an upper surface of the base plate 2, the reference block 9 is fixed to the base plate 2 by a fastening bolt 10 so as to be partially buried into the installation hole 8. A central pillar 12 is integrally formed with the reference block 9 so as to be projected from the reference block 9 upward, and the central pillar 12 is allowed to be inserted into the positioning hole 5 formed in the work pallet 3. The axis of the central pillar 12 substantially coincides with the axis of the installation hole 8.

On an outer periphery of the central pillar 12 is formed a inclined outer surface 13 in such a manner that the inclined outer surface 13 gradually gets closer to the axis upward (toward a leading end of the central pillar 12).

Outside the central pillar 12 is arranged an annular intermediate member 15. The intermediate member 15 is formed in a cylindrical shape and is adapted to be elastically deformable radially outwardly by providing one slit 18 in its peripheral wall. And the intermediate member 15 is adapted to be restorable radially inwardly by its own elastic restoring force.

Outside the intermediate member 15 is fitted a seamlessly-formed outer ring 20, by which foreign matter such as swarf is prevented from entering the inside of a plug portion 27 described later via the slit 18.

On an outer peripheral surface of the intermediate member 15 is formed a straight outer surface 16 which is allowed to come into close contact with an inner peripheral surface of the positioning hole 5. Meanwhile, on an inner peripheral surface of the intermediate member 15 is formed a inclined inner surface 17 which faces the inclined outer surface 13 of the central pillar 12. As well as the inclined outer surface 13 is, the inclined inner surface 17 is also formed in such a manner that the inclined inner surface 17 gradually gets closer to the axis upward (toward the leading end of the central pillar 12).

It is noted that a pin 19 is radially projected from the outer peripheral surface of the central pillar 12, and a projected portion of the pin 19 is inserted into the slit 18 of the intermediate member 15, by which the rotation of the intermediate member 15 is prohibited.

On the reference block 9 is supported a pull member 21 movably along the axial direction of the central pillar 12. The pull member 21 is composed of a piston 22 hermetically inserted into a lower part of the reference block 9, a piston rod 23 integrally formed with the piston 22 and projected upward from the piston 22 and axially inserted into an axial hole of the central pillar 12, a cap 37 fixed on an upper portion of the piston rod 23 by a bolt 24 and a flat ring 26 attached between a lower surface of the cap 37 and an upper end surface of the piston rod 23.

As illustrated in FIG. 1(a), on an outer peripheral surface of the ring 26 is formed a collar portion, and into an annular groove formed by the collar portion and the cap 37 is fitted an upper flange formed at an upper portion of the intermediate member 15. As described, the pull member 21 and the intermediate member 15 are connected to each other.

Inside the reference block 9 is provided a lock means and a release means. The lock means thereamong is composed of both the piston 22 and a coil spring-like urging spring 34 arranged on the upper side of the piston 22. The release means thereamong is composed of both the piston 22 and an hydraulic chamber 35 provided for releasing formed on the lower side of the piston 22.

In the above-described present embodiment, a plug portion 27 of the present invention is composed of the central pillar 12, the cap 37, the intermediate member 15, the ring 26 and the like. The plug portion 27 is projected from the base plate 2 so as to be inserted into the positioning hole 5. And the straight outer surface 16, which is the outer peripheral surface of the intermediate member 15 forms an outer peripheral surface of the plug portion 27, namely forms a fitting surface which is allowed to come into close contact with the inner peripheral surface of the positioning hole 5.

And on the fitting surface (straight outer surface) 16 is opened a jet hole 38 as a fluid flow hole. The jet hole 38 is adapted to be closed by the inner peripheral surface of the positioning hole 5 when the fitting surface 16 comes into close contact with the inner peripheral surface of the positioning hole 5 of the work pallet 3 during a locking operation described later.

It is noted that at a lower surface of the reference block 9 is provided an air port 39 as a fluid port, and in the inclined outer surface 13 of the central pillar 12 is formed a relay opening 41. And the air port 39 and the relay opening 41 are communicatively connected to each other via an air passage 40 formed inside the reference block 9. Then the jet hole 38 formed in the intermediate member 15 is opened so as to radially penetrate the intermediate member 15, more specifically, so that one end is opened in the straight outer surface 16 and the other end is opened in the inclined inner surface 17 respectively, and the other end faces the relay opening 41.

The above described automatic positioning apparatus operates as follows. In the released state illustrated in FIG. 1(a) and FIG. 1(b), pressurized oil has been supplied to the hydraulic chamber 35, by which the piston 22 has ascended with the piston rod 23 against an urging force of the urging spring 34, and the intermediate member 15 has ascended as well. As a result, the state of the intermediate member 15 has been switched into a radially contracted state. Here, between an upper end surface of the central pillar 12 and a lower surface of the ring 26 is formed a contact gap.

To position the work pallet 3 in relation to the base plate 2 in this released state, first, as illustrated in FIG. 1(a), the work pallet 3 is lowered by any appropriate means (not illustrated), the intermediate member 15 is inserted into the positioning hole 5, and the supported surface 3a of the work pallet 3 is brought into contact with the support surface 9a of the reference block 9. By discharging the pressurized oil of the hydraulic chamber 35 in this state, the piston 22 is lowered by the urging force of the urging spring 34, and the intermediate member 15 is also strongly moved downward (toward the base end of the central pillar 12) for locking. Thereby, as illustrated in FIG. 2(a) and FIG. 2(b), the state of the intermediate member 15 is switched into an radially expanded state, and the straight outer surface 16, which is the outer peripheral surface of the intermediate member 15, comes into close contact with the inner peripheral surface of the positioning hole 5. As a result, the horizontal fixation (above-described alignment) of the work pallet 3 is performed. It is noted that during the locking operation, the intermediate member 15 is desirably prevented from descending by more than a predetermined range by the contact between the lower surface of the ring 26 and the upper end surface of the central pillar 12.

The locked state is allowed to develop as described above and the work pallet 3 can be positioned and clamped in relation to the base plate 2. However, in such a case that swarf produced during machine work and the like is adhered on the inner peripheral surface of the positioning hole 5, there may be a possible abnormal clamping, that is a clamping with the swarf caught between the inner peripheral surface of the positioning hole 5 and the straight outer surface 16 of the intermediate member 15 during the above-mentioned clamping operation.

However, in the present embodiment, since the jet hole 38 is provided on the straight outer surface 16, it is possible to properly detect the above-mentioned abnormal clamping by introducing compressed air into the air port 39 of the reference block 9 after the clamping operation.

That is, in a case that clamping operation has properly performed, namely, in the case that the straight outer surface 16 has come into close contact with the inner peripheral surface of the positioning hole 5 and the jet hole 38 is closed by the inner peripheral surface of the positioning hole 5, air leakage from the jet hole 38 can be prevented or kept to a minimum level, resulting in that the pressure increases inside the air port 39. By checking the increase of the pressure using a pressure sensor (not illustrated), it is possible to recognize that the clamping operation has been properly conducted.

Meanwhile, in a case that a gap is left between the straight outer surface 16 and the inner peripheral surface of the positioning hole 5 for some reason, for example, due to swarf caught therebetween, compressed air leaks from the jet hole 38 via the gap in a great quantity, resulting in that the pressure inside the air port 39 does not increase. By measuring the pressure at the air port 39, it is possible to recognize that some abnormal clamping operation has been performed in a case that the pressure at the air port 39 is lower than a predetermined value.

Particularly, the plug means 6 of the present embodiment is, as previously described, constituted in such a way that the plug portion 27 is inserted into the positioning hole 5 and the outer peripheral surface of the plug portion 27 is brought into close contact with the inner peripheral surface of the positioning hole 5 to perform clamping. Therefore, during the clamping operation, since the plug portion 27 is concealed inside the positioning hole 5, it is completely impossible or extremely difficult to visually confirm whether an appropriate clamping operation is performed or not from the outside. In this respect, with the structure presented as the present embodiment, it is possible to reliably detect whether the clamping operation is properly performed or not on the basis of the pressure inside the air port 39.

The explanation has been made for the operation to switch the state from the released state into the locked state, on the contrary, to switch from the locked state into the released state, pressurized oil is supplied to the hydraulic chamber 35 in the state illustrated in FIG. 2(a). Thereby, the piston rod 23 ascends with the piston 22 against the urging force of the urging spring 34, and the intermediate member 15 moves upward (toward the leading end of the central pillar) for releasing, resulting in that the intermediate member 15 radially contracts by its own elastic restoring force, and the locked state is released. Thereafter, the work pallet 3 is allowed to be raised by any appropriate means.

The first embodiment of the present invention is as described above, however, this embodiment can be changed as described below.

The structure presented in the first embodiment is constituted in such a way that compressed air is supplied to the air port 39 and the air is jetted from the jet hole 38, however, the structure may also be constituted in such a way that air is sucked into the jet hole 38 using vacuum drawing at the air port 39. Namely, the port numbered 39 (fluid port) is regarded as a fluid suction port and the hole numbered 38 (fluid flow hole) is regarded as a fluid suction hole. This structure is advantageous in a case where a clamping apparatus is installed, for example, in a clean room where dust-free conditions are needed. However, the structure presented as the first embodiment where the compressed air is supplied to the air port 39 is more advantageous than the structure using vacuum drawing where the pressure cannot be made lower than 0 atm (Zero atm) because the structure presented as the first embodiment is constituted in such a way that compressed air at a high pressure (for example 10 atm or higher) is supplied to the air port 39 so as to reliably detect a slight gap.

The intermediate member 15 presented as the first embodiment may be provided with a plurality of radial through grooves opened alternately on an upper surface and a lower surface of its peripheral wall and the plurality of radial through grooves are arranged in the circumferential direction, instead of provided with the one slit 18 in its peripheral wall. The intermediate member 15 may also be constituted with a plurality of divided members arranged in the circumferential direction. In addition, it is not necessary to form substantially the entire circumference of the peripheral wall of the intermediate member 15 so as to be deformable radially outward and- radially inward, instead, it is possible to form at least a part of the circumference of the peripheral wall of the intermediate member 15 so as to be deformable radially outward and radially inward.

The central pillar 12 may be indirectly engaged with the intermediate member 15 via another member, instead of that the central pillar 12 is directly engaged with the intermediate member 15 as presented.

It is noted that it is preferable that the plug means 6 is provided with a cleaning means and that a contacting part of the support surface 9a with the supported surface 3a, the inner peripheral surface of the positioning hole 5, the straight outer surface 16 of the intermediate member 15, the engaged surfaces between the central pillar 12 and the intermediate member 15 and the like are cleaned using pressurized fluid such as compressed air, nitrogen, cutting oil and the like.

Here, it is possible that to blow off the swarf and the like described above, more specifically, to clean the inner peripheral surface of the positioning hole 5 and the straight outer surface 16 of the intermediate member 15 and the like using compressed air jetted out from the jet hole 38 by supplying the compressed air to the air port 39 before the compressed oil in the hydraulic chamber 35 is discharged (namely, before the locking operation). In this instance, a mechanically simple plug means 6 can be obtained by forcing the above-mentioned compressed air (compressed fluid) supplied to the air port 39 which is used to detect an abnormal clamping serves as the cleaning fluid. And, in a case where the jet hole 38 is clogged by foreign matter such as swarf, the foreign matter can be blown out and removed by jetting air from the jet hole 38 before the straight outer surface 16 comes into close contact with the inner peripheral surface of the positioning hole 5. Therefore, the above-mentioned structure has an advantage of avoiding such a problem that the blockage of the jet hole 38 is undesirably detected as a proper clamping due to the increase of the pressure on the air port 39 side.

As a matter of course, another jet hole for the cleaning fluid may be formed in the outer peripheral surface of the plug portion 27 besides the above-mentioned jet hole 38 formed in the outer peripheral surface 16 of the intermediate member 15, and the cleaning fluid may be jetted out from the added jet hole. The jet hole for the cleaning fluid can be formed by branching the air passage 40. Further, a port exclusively for the cleaning fluid may be formed on the reference block 9, and the added jet hole for the cleaning fluid may be connected to the port via an another passage other than the air passage 40.

In the above embodiment, the pressurized fluid supplied to the air port 39 is (compressed) air, however, different fluid may also be available. For example, cutting oil and the like may be supplied to the jet hole 38 instead of the above-described air.

### Second Embodiment

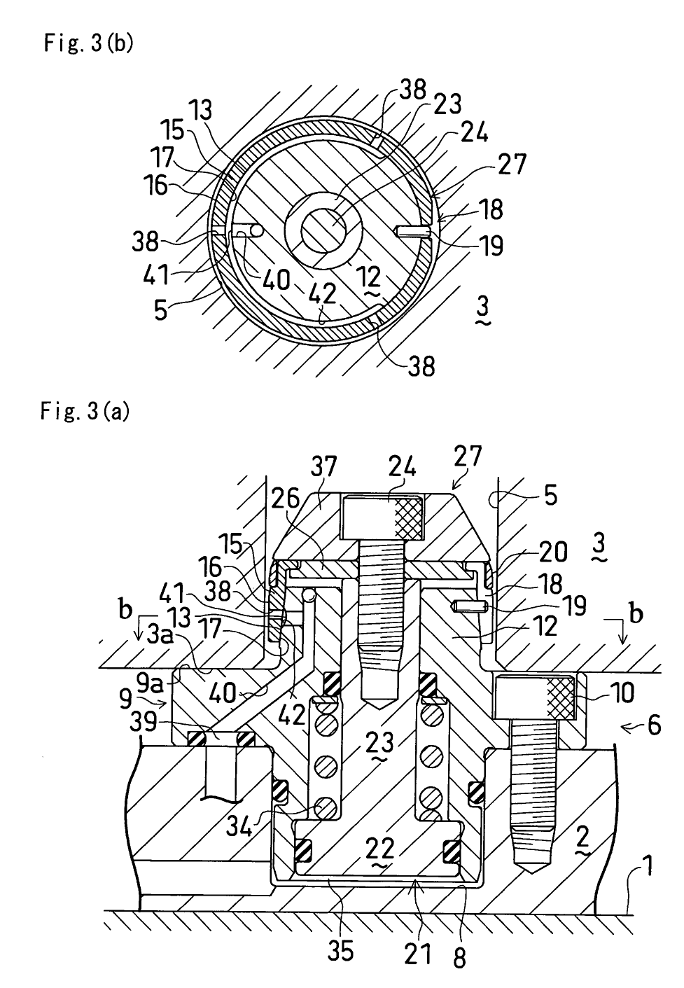

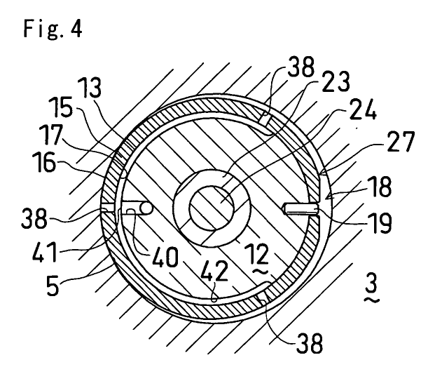

An explanation will be made for a second embodiment by referring to FIG. 3(a), FIG. 3(b) and FIG. 4. FIG. 3(a) is an elevated cross-sectional view showing a released state of the clamping apparatus according to the second embodiment of the present invention, and FIG. 3(b) is a cross-sectional view indicated by the arrow b-b in FIG. 3(a). FIG. 4 is a plain cross-sectional view of the clamping apparatus in which the axis of the plug portion is misaligned with the axis of the positioning hole and one of the jet holes is closed, and similar to FIG. 3(b). In this second embodiment, components similar to those of the above-mentioned first embodiment will be designated and described by the same numerals as a general rule. The same is applied to a third embodiment and subsequent embodiments to be explained later.

The structure of the second embodiment is different from that of the first embodiment in that the jet holes 38 are provided circumferentially in plurality on the outer peripheral surface of the plug portion 27. Hereinafter the second embodiment will be concretely explained.

As illustrated in FIG. 3(a) and FIG. 3(b), on the outer peripheral surface (the inclined outer surface 13) of the central pillar 12 is provided a communication groove (communicative passage) 42 in the shape of an arc when viewed on a plane. At the middle of the communication groove 42 is formed the relay opening 41, which is one end of the air passage 40.

As illustrated in FIG. 3(b), the jet holes 38 are provided in three in the intermediate member 15 circumferentially at the same intervals. Each of these three jet holes 38 is opened in such a way that one end is opened in the straight outer surface 16 and the other end is opened in the inclined inner surface 17. The other end of each of the jet holes 38 faces the communication groove 42.

With the above-described structure, compressed air supplied to the air port 39 is supplied to the communication groove 42 from the relay opening 41 via the air passage 40, and the compressed air is divided among the three jet holes 38, then the divided compressed air is jetted out from each of the jet holes 38.

Since the jet holes 38 are provided in plurality in the present embodiment, even when one of the jet holes 38 is clogged by swarf for example, as long as the remaining jet holes 38 are closed by the inner peripheral surface of the positioning hole 5, the pressure on the air port 39 side increases, otherwise as long as the remaining jet holes 38 are not closed by the inner peripheral surface of the positioning hole 5, the pressure on the air port 39 side does not increase. Namely, as long as all of the plurality of the jet holes 38 are not closed by foreign matter, the pressure on the air port 39 side does not increase, resulting in that the above-mentioned state is properly detected as an abnormal clamping. With the above-mentioned structure, the detection reliability is improved and the frequency of a wrong detection is reduced.

Particularly, in the present embodiment, since the jet holes 38 are provided circumferentially in plurality, a state illustrated in FIG. 4 can also be reliably detected as an abnormal clamping. FIG. 4 shows a case where an expected locking operation is not performed due to some causes such as a failure in hydraulic equipment. As illustrated in FIG. 4, there may be a case where although the straight outer surface 16 does not come into close contact with the inner peripheral surface of the positioning hole 5, since a misalignment occurs between the axis of the plug portion 27 and the axis of the positioning hole 5 accidentally or due to foreign matter caught between the straight outer surface 16 and the inner peripheral surface of the positioning hole 5, one of the plurality of the jet holes 38 (that illustrated on the left side in FIG. 4) is brought into contact with the inner peripheral surface of the positioning hole 5 and closed therefore. In the structure of the first embodiment (FIG. 1(b)), if the above-described single jet hole 38 is closed, the pressure increases on the air port 39 side, resulting in a wrong detection that a normal clamping seems to be performed. However, in the second embodiment, even when the state illustrated in FIG. 4 is found, the remaining two jet holes 38 are not closed and the pressure on the air port 39 side does not increase, thereby it is possible to reliably detect an abnormal clamping.

It is noted that the structure of the present embodiment may also be constituted in such a way that compressed air is supplied to the air port 39 not only in the above-described locked state but also in the released state so as to confirm that the straight outer surface 16 does not come into close contact with the inner peripheral surface of the positioning hole 5. The above-described structure of the second embodiment is available for the structure mentioned above as well. More specifically, in the released state, as illustrated in FIG. 4, there may be a case where although the straight outer surface 16 does not come into close contact with the inner peripheral surface of the positioning hole 5, since a misalignment occurs between the axis of the plug portion 27 and the axis of the positioning hole 5 accidentally or due to foreign matter caught between the straight outer surface 16 and the inner peripheral surface of the positioning hole 5, one of the plurality of the jet holes 38 (that illustrated on the left side in FIG. 4) is brought into contact with the inner peripheral surface of the positioning hole 5 and closed by accident. In the structure of the first embodiment (FIG. 1(b)), if the above-described single jet hole 38 is closed, the pressure on the air port 39 side increases, resulting in a wrong detection that an abnormal releasing operation seems to be performed. However, in the second embodiment, even when the state illustrated in FIG. 4 is found, the remaining two jet holes 38 are not closed and the pressure on the air port 39 side does not increase, thereby it is possible to correctly detect that the straight outer surface 16 does not come into close contact with the inner peripheral surface of the positioning hole 5.

Further, the structure of the present embodiment is constituted in such a way that the air passage 40 extending from the air port 39 is branched via the communication groove 42 in the circumferential direction and communicatively connected to each of the jet holes 38, thereby it is not necessary to check the pressure at each of the jet holes 38. An abnormal clamping can be detected only by checking the pressure on the air port 39 side, thus a mechanically simple fluid passage and a mechanically simple structure for detecting the pressure can be obtained.

In the second embodiment, the jet holes 38 are provided in three but may be provided in two or in four or more. Further, the communication groove 42 may be provided on the inclined inner surface 17 of the intermediate member 15, instead of provided on the inclined outer surface 13 of the central pillar 12.

### Third Embodiment

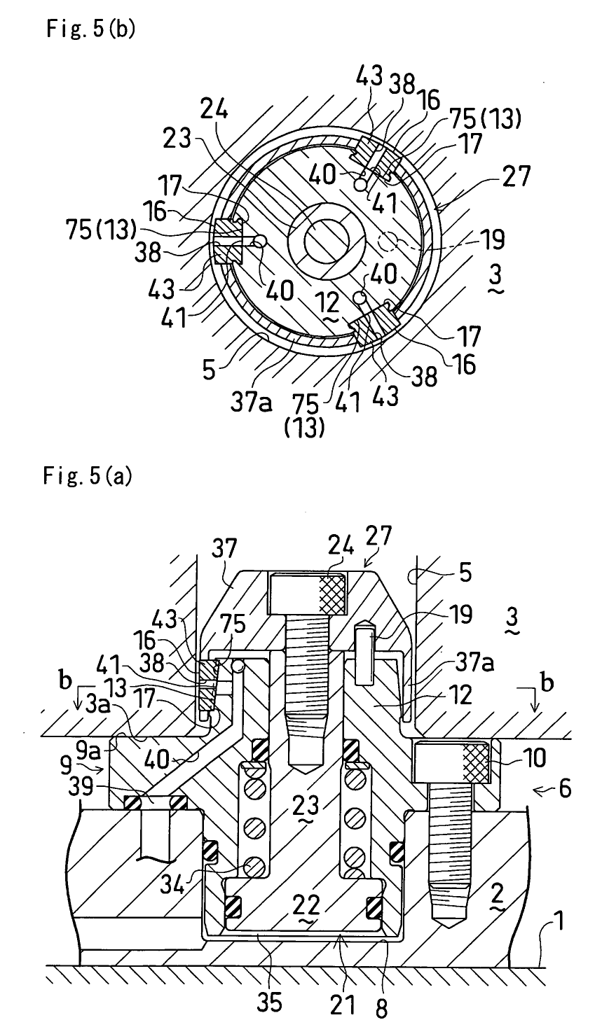

An explanation will be made for the third embodiment by referring to FIG. 5(a) and FIG. 5(b). FIG. 5(a) is an elevated cross-sectional view showing a released state of the clamp apparatus according to the third embodiment of the present invention. FIG. 5(b) is a cross-sectional view indicated by the arrow b-b in FIG. 5(a).

As illustrated in FIG. 5(b), three inclined grooves 75 are provided circumferentially at intervals on the outer surface of the central pillar 12. The bottom surface of each of the inclined grooves 75 forms a inclined wedge surface, which is the inclined outer surface 13. A support wall 37a is extended out cylindrically from the lower end of the cap 37 toward the base end side of the central pillar 12, and the support wall 37a is formed seamlessly in the circumferential direction without any slits. Three pressing members 43 are arranged on the support wall 37a circumferentially at intervals and supported on the supported wall 37a radially movably. The pressing members 43 is connected to the pull member 21 (specifically, the cap 37).

On an inner surface of each of the pressing members 43 is formed an inclined wedge surface as the inclined inner surface 17, and the inclined inner surface 17 is wedge-engaged with the inclined outer surface 13 from above. In the substantially middle of the outer surface of each of the pressing members 43, which is the straight outer surface 16 allowed to come into close contact with the inner peripheral surface of the positioning hole 5, is formed each of the jet holes 38. It is noted that the rotation of the cap 37 is prohibited by a pin 19 projected upward from the central pillar 12.

As illustrated in FIG. 5(b), each of the inclined grooves 75 is formed in a T shape when viewed on a plane, and with the fitting structure composed of both the side walls of the inclined groove 75 and the inner end portion of the pressing members 43, the pressing members 43 are adapted to be restorable radially inward during the movement for releasing. Namely, the fitting structure operates as a restoring means.

The operation of the third embodiment is different from that of the first embodiment in that, during the locking operation, each of the pressing members 43 supported on the support wall 37a is moved for locking toward the base end of the central pillar 12 by the pull member 21 and also projected radially outward, by which the outer surface of each of the pressing members 43 comes into close contact with the positioning hole 5. More specifically, the straight outer surface 16, which is the outer surface of each of the pressing members 43, forms the outer peripheral surface of the plug portion 27, and also corresponds to the fitting surface to be brought into close contact with the inner peripheral surface of the positioning hole 5. In contrast, during the releasing operation, each of the pressing members 43 is moved for releasing toward the leading end of the central pillar 12 by the pull member 21 and also moved radially inward.

It is noted that, in the third embodiment as well, the air passage 40 is connected to the air port 39 formed in the reference block 9 and in the inclined outer surface 13 is opened the relay opening 41, which is one end of the air passage 40. In each of the pressing members 43, the jet hole 38 is provided so that one end is opened in the straight outer surface 16 and the other end is opened in the inclined inner surface 17, and the other end faces the relay opening 41.

In the third embodiment, the jet hole 38 is provided in each of all the three pressing members 43, however, for example, the jet hole 38 may be provided in one or two pressing members 43 among the three pressing members 43 instead. In the third embodiment, the pressing members 43 are provided in three, however, there is no restriction thereto, that is, the pressing members 43 may be provided in two or in four or more.

Further, the structure presented in the third embodiment is constituted in such a way that compressed air is supplied to the air port 39 in order to jet the air from the jet holes 38, however, the structure may also be constituted in such a way that air is sucked into the jet holes 38 using vacuum drawing at the air port 39. It is noted that the structure presented in the fourth through the sixth embodiment described later may also be constituted in such a way that air is sucked into the jet holes 38 using vacuum drawing at the air port 39.

In addition, the restoring means may be composed of an elastic member such as a spring or rubber which urges the pressing members 43 radially inward, instead of that the restoring means is composed of the fitting structure composed of both the inclined groove 75 and the pressing member 43.

### Fourth Embodiment

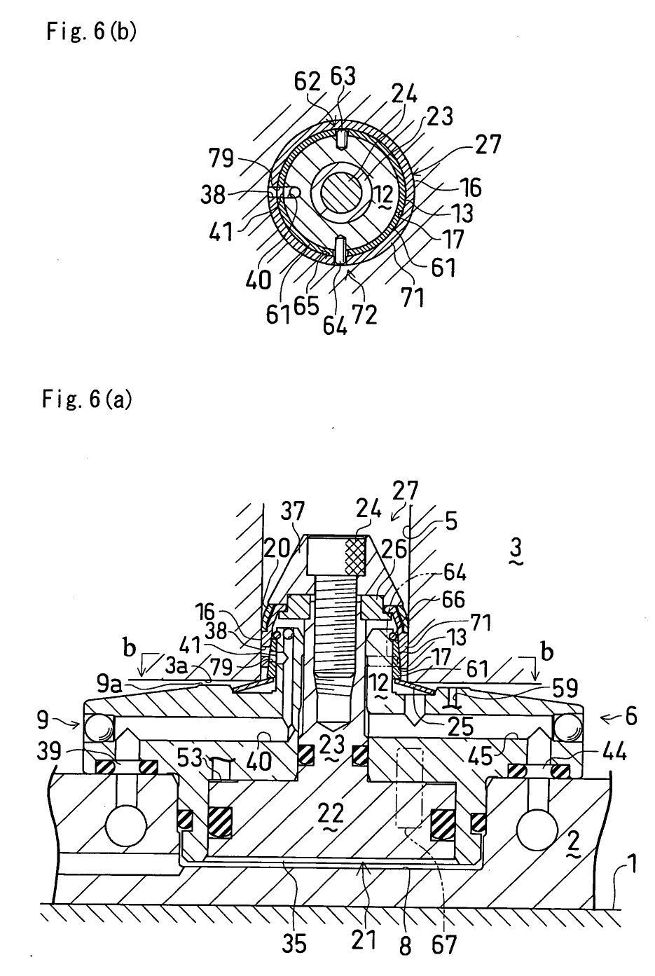

An explanation will be made for a fourth embodiment by referring to FIG. 6(a) and FIG. 6(b). FIG. 6(a) is an elevated cross-sectional view showing a locked state of the clamping apparatus according to the fourth embodiment of the present invention, and FIG. 6(b) is a cross-sectional view indicated by the arrow b-b in FIG. 6(a).

As illustrated in FIG. 6(a), in the fourth embodiment, the central pillar 12 is integrally formed with the reference block 9 in such a way that the central pillar 12 is projected upward from the reference block 9, and the outer peripheral surface of the central pillar 12 is not formed into the inclined outer surface but formed into a straight surface. The upper surface of the reference block 9 is annularly projected to a slight extent around a base end portion of the central pillar 12, and on an upper surface of the projected portion is formed the flat support surface 9a. The support surface 9a faces the supported surface 3a of the work pallet 3.

Onto the outer periphery of the central pillar 12 is fitted an inner sleeve 61 axially (vertically) movably along the axis of the central pillar 12 within a predetermined range. In a peripheral wall of the inner sleeve 61 is formed one slit 62 extending vertically, by which the inner sleeve 61 is adapted to be diametrically expandable and diametrically contractible, and the inner sleeve 61 is kept slightly expanded radially outward by its own elastic restoring force. It is noted that, as illustrated in FIG. 6(b), two stopper pins 63 and 64 are radially projected on the central pillar 12, and the stopper pin 63 is inserted into the slit 62 and the stopper pin 64 is inserted into a loose hole 65 formed on the inner sleeve 61. It is desirable that a sealing member (not illustrated) made of rubber and the like is attached to the slit 62.

As illustrated in FIG. 6(a), one coned disc spring (advancing means) 25 is arranged between the inner sleeve 61 and the reference block 9, and the inner sleeve 61 is urged upwardly by the coned disc spring 25. It is noted that a retaining ring 66 is fitted onto an upper portion of the central pillar 12, and the upper end of the inner sleeve 61 is received by the retaining ring 66, thereby the upper end of the vertical stroke of the inner sleeve 61 is provided.

On an outer periphery of the inner sleeve 61 is provided the inclined outer surface 13 in a tapered manner so as to gradually gets closer to the axis upwardly (toward the leading end of the central pillar 12).

On the outside of the inner sleeve 61 is arranged an annular outer sleeve 71. The outer sleeve 71 is formed in a collet shape and also in an approximately cylindrical shape, and one slit 72 is formed in the peripheral wall of the outer sleeve 71, by which the outer sleeve 71 is adapted to be elastically deformable radially outward. In addition, the outer sleeve 71 is adapted to be restorable radially inward by its own elastic restoring force. Into the slit 72 is inserted the stopper pin 64, by which the rotation of the outer sleeve 71 is prohibited. It is desirable that a sealing member (not illustrated) made of rubber and the like is attached to the slit 72.

On an outer peripheral surface of the outer sleeve 71 is formed the straight outer surface 16 allowed to be brought into close contact with the inner peripheral surface of the positioning hole 5. Meanwhile, on an inner surface of the outer sleeve 71 is formed the inclined inner surface 17 which faces the inclined outer surface 13 of the inner sleeve 61. The inclined inner surface 17 is also formed in such a manner that the inclined inner surface 17 gradually gets closer to the axis upwardly (toward the leading end of the central pillar 12).

Into the reference block 9 is inserted the pull member 21 vertically movably. The pull member 21 is, substantially as well as the first embodiment, provided with a piston 22 hermetically inserted into a lower part of the reference block 9, a piston rod 23 integrally formed with the piston 22 so as to be projected upward from the piston 22 and axially inserted into an axial hole of the central pillar 12, a cap 37 fixed on an upper portion of the piston rod 23 by a bolt 24 and a ring 26 attached between a lower surface of the cap 37 and an upper end surface of the piston rod 23. A collar portion is formed on an outer peripheral surface of the ring 26, and into an annular groove formed by the collar portion and the cap 37 is fitted an upper flange formed at an upper portion of the outer sleeve 71. As a result, the outer sleeve 71 and the pull member 21 are connected to each other.

In the present embodiment, the plug portion 27 of the present invention is composed of the central pillar 12, the cap 37, the inner sleeve 61, the outer sleeve 71 and the like. This plug portion 27 is formed in a projected shape from the base plate 2 so as to be inserted into the positioning hole 5. Then, the straight outer surface 16, which is the outer peripheral surface of the outer sleeve 71, forms an fitting surface which is adapted to come into close contact with the inner peripheral surface of the positioning hole 5.

Inside the reference block 9 are provided a lock means and a release means. The lock means thereamong is composed of both the piston 22 and an hydraulic chamber 53 provided for locking formed on the upper side of the piston 22. The release means thereamong is composed of both the piston 22 and an hydraulic chamber 35 provided for releasing formed on the lower side of the piston 22. It is noted that into the piston 22 is vertically inserted one end of the pin 67, the other end is locked to the reference block 9, and the rotation of the pull member 21 is prohibited by the pin 67.

In the reference block 9 is provided an air port 39, and the air port 39 is connected to an air passage 40 formed inside the reference block 9. One end of the air passage 40 forms a relay opening 41 in an outer peripheral surface of the central pillar 12. The relay opening 41 is communicatively connected to an jet hole 38 formed in the outer sleeve 71 via a communication hole 79 formed in the inner sleeve 61 in a penetrating manner.

In the support surface 9a of the reference block 9 is provided a seating confirmation means. Namely, in the support surface 9a is opened a detection nozzle hole 59, and compressed air for detection is supplied to the detection nozzle hole 59. When the supported surface 3a is brought into contact with the support surface 9a, the pressure at the detection nozzle hole 59 increases. By checking this pressure rise using a pressure sensor (not illustrated), it is possible to confirm that the work pallet 3 is seated on the reference block 9.

In addition, on the reference block 9 is provided a cleaning means. Namely, a cleaning port 44 is provided on the reference block 9, and a cleaning passage 45 is connected to the cleaning port 44. When compressed air is supplied to the cleaning port 44, the compressed air is blown to the coned disc spring 25, the inner sleeve 61, the outer sleeve 71 and the inner peripheral surface of the positioning hole 5 via the cleaning passage 45, thereby it is possible to blow away and remove foreign matter such as swarf.

An explanation will be made for the operation of the plug means 6 of the fourth embodiment. In the released state illustrated in FIG. 6(a) and FIG. 6(b), pressurized oil in the hydraulic chamber 53 provided for locking has been discharged and pressurized oil has been supplied to the hydraulic chamber 35 provided for releasing. Thereby, the piston 22 has ascended and the outer sleeve 71 ascended as well, resulting in that the state of the outer sleeve 71 is switched into a radially contracted state. In addition, the inner sleeve 61 has ascended by the advancing stroke of the coned disc spring 25, and the inner sleeve 61 has made a slight tapering engagement with the outer sleeve 71 or has faced the outer sleeve 71 with a slight gap left.

In this released state, the work pallet 3 is lowered in order to fit the positioning hole 5 onto the outer sleeve 71. It is noted that, during this fitting movement, it is preferable that compressed air is supplied to the cleaning port 44 in order to blow away and remove swarf and the like attached to various parts of the plug portion 27. A lower surface of the work pallet 3 is received by the coned disc spring 25, thereby a slight gap is formed between the supported surface 3a and the support surface 9a. Therefore, even when compressed air is supplied to the detection nozzle hole 59 in this state, the pressure at the detection nozzle hole 59 does not increase due to air leakage from the gap.

Thereafter, the pressurized oil is discharged from the hydraulic chamber 35 provided for releasing, and pressurized oil is supplied to the hydraulic chamber 53 provided for locking. Then, the piston 22 lowers the outer sleeve 71 via the piston rod 23 and the cap 37, and the piston 22 forces the inclined inner surface 17 of the outer sleeve 71 to wedge-engage with the inclined outer surface 13 of the inner sleeve 61 gradually. Therefore, the outer sleeve 71 and the inner sleeve 61 and others operates as follows.

First, the outer sleeve 71 is expanded via the inner sleeve 61 which is held substantially at an raised position by an urging force of the coned disc spring 25, and the outer sleeve 71 is brought into contact with the positioning hole 5. Next, the outer sleeve 71 is expanded with the coned disc spring 25 gradually compressed downwardly via the inner sleeve 61, and the outer sleeve 71 comes into close contact with the inner peripheral surface of the positioning hole 5, thereby the work pallet 3 is positioned in the horizontal direction. During this horizontal positioning operation, between the support surface 9a and the supported surface 3a is left a contact gap.

It follows that the outer sleeve 71 which is brought into close contact with the inner peripheral surface of the positioning hole 5 pulls the work pallet 3 downward via the positioning hole 5, and at the same time, the outer sleeve 71 gradually lowers the inner sleeve 61 against the urging force of the coned disc spring 25. Thereby, the supported surface 3a of the work pallet 3 is brought into contact with the support surface 9a of the reference block 9, and the supported surface 3a is pressed against the support surface 9a. Thereafter, the outer sleeve 71 is gradually lowered with a frictional slide in relation to the positioning hole 5 of the work pallet 3 which is prevented from descending due to the support surface 9a. When the outer sleeve 71 lowers the inner sleeve 61 by the distance corresponding to the advancing stroke against the urging force of the coned disc spring 25, the inner sleeve 61 is received by the reference block 9 via the coned disc spring 25. Then, the outer sleeve 71 strongly makes a wedge-engagement with the inner sleeve 61 and the outer sleeve 71 expands, by which the outer sleeve 71 comes into close contact with the inner peripheral surface of the positioning hole 5. As a result, the work pallet 3 is restricted horizontally and vertically and the work pallet 3 is locked strongly.

In the above-described locked state, the detection nozzle hole 59 is closed by the supported surface 3a and the jet holes 38 are closed by the inner peripheral surface of the positioning hole 5. Therefore, by checking the existence of the pressure rise at the air port 39 and the detection nozzle hole 59, it is possible to judge whether a proper clamping operation has been performed or not.

To switch the state of the clamping apparatus from the locked state into the released state, pressurized oil of the hydraulic chamber 53 provided for locking is discharged and pressurized oil is supplied to the hydraulic chamber 35 provided for releasing. Thereby, the outer sleeve 71 is raised by the pull member 21 composed of the piston 22, the piston rod 23 and the cap 37 and the like, and the ascending outer sleeve 71 radially contracts by its own elastic restoring force, resulting in that the locked state is released.

In the fourth embodiment, the jet hole 38 is provided in one, however, the jet holes 38 may be provided in plurality. Substantially as well as the second embodiment (FIG. 3(b)) where the communication groove 42 is provided, it is preferable that a communication groove as a passage is provided on the inclined outer surface 13 of the inner sleeve 61 or the inclined inner surface 17 of the outer sleeve 71, and an opening end on the inclined inner surface 17 side of each of the jet holes 38 faces the communication groove.

### Fifth Embodiment

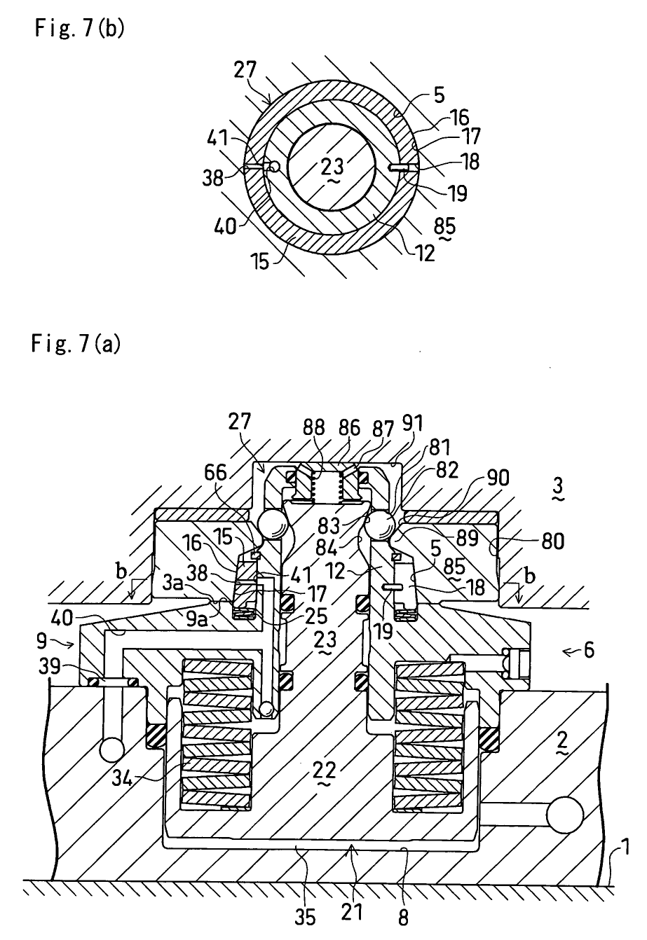

An explanation will be made for the fifth embodiment by referring to FIG. 7(a) and FIG. 7(b). FIG. 7(a) is an elevated cross-sectional view showing a locked state of the clamping apparatus according to the fifth embodiment of the present invention FIG. 7(b) is a cross-sectional indicated by the arrow b-b in FIG. 7(a).

In the clamping apparatus of the fifth embodiment, as illustrated in FIG. 7(a), in the lower surface of the work pallet 3 is opened a fixing hole 80, and onto the fixing hole 80 is fixed a positioning ring 85 using a bolt (not illustrated). The positioning ring 85 is provided with a positioning hole 5, around the positioning hole 5 is annularly projected a lower surface of the positioning ring 85, and the lower surface of the annular projection forms a supported surface 3a. On an upper portion of an inner peripheral surface of the positioning hole 5 is formed a narrow portion 89, and at an upper part of the narrow portion 89 is formed a pressure-receiving surface 90 which gradually narrows downward (toward the opening end side of the positioning hole 5).

To the base plate 2 is fixed a reference block 9 using a bolt (not illustrated), and an annular central pillar 12 is projected upward from the reference block 9 so as to be inserted into the positioning hole 5. An outer peripheral surface of the central pillar 12 is formed in a straight manner. In addition, around the base end portion of the central pillar 12 is annularly projected the upper surface of the reference block 9, and on the upper surface of the annular projection is formed a support surface 9a which faces the supported surface 3a.

Outside the central pillar 12 is arranged an annular intermediate member 15 vertically movably. The peripheral wall of the intermediate member 15 is provided with one slit 18, and the intermediate member 15 is adapted to be radially expandably and radially contractibly deformable by the slit 18.

On an outer peripheral surface of the intermediate member 15 is formed a tapered fitting surface 16. In response thereto, on an inner peripheral surface of the positioning hole 5 of the positioning ring 85 is formed a tapered inner surface (inclined inner surface) 17 allowed to make an engagement with the tapered fitting surface 16.

The tapered fitting surface 16 forms a fitting surface allowed to come into close contact with the inner peripheral surface (the tapered inner surface 17) of the positioning hole 5. The tapered fitting surface 16 and the tapered inner surface 17 are formed in such a shape that they gradually gets closer to the axis toward the leading end of the central pillar 12.

Between the intermediate member 15 and the reference block 9 are arranged a plurality of coned disc springs (advancing means) 25 in a laminated manner. Thereby, the intermediate member 15 is urged by the coned disc springs 25 upward (namely, in such a direction to tighten the tapering engagement between the tapered fitting surface 16 and the tapered inner surface 17). It is noted that, at the middle portion of the central pillar is attached a retaining ring 66 which is provided for receiving an upper end portion of the intermediate member 15, thereby the upper end of the vertical stroke of the intermediate member 15 is provided.

Into the lower portion of the reference block 9 is hermetically inserted a piston 22. A piston rod 23 is integrally formed with the piston 22 in such a way that the piston rod 23 is projected upward from the piston 22, and the piston rod 23 is axially inserted into the axial hole of the central pillar 12. Meanwhile, at the upper portion of the central pillar 12 are formed a plurality of through holes 81 circumferentially at predetermined intervals, and hard balls 82 are supported radially movably on each of these through holes 81 respectively. At the outer end of the through hole 81 is formed a narrow portion, by which the hard ball 82 is prevented from getting out of the through hole 81 and from dropping. On an upper portion of the outer peripheral surface of the piston rod 23 is formed an output inclined surface 83 and an evacuating groove 84 vertically overlapped in such that the output inclined surface 83 and the evacuating groove 84 is allowed to face the hard balls 82. In the present embodiment, the pull member 21 includes the piston 22, the piston rod 23, the hard balls 82 and the output inclined surface 83.

On an upper end portion of the central pillar 12 is hermetically supported a transmission member 86, and the transmission member 86 is vertically movable. The transmission member 86 is provided with a cleaning hole 87 and when compressed air is supplied to a cleaning port (not illustrated) formed in the reference block 9, the compressed air is jetted from the cleaning hole 87, thereby the inner peripheral surface (the tapered inner surface 17) of the positioning hole 5 and others are adapted to be cleaned. Between the transmission member 86 and the upper end surface of the piston rod 23 is resiliently installed an urging spring 88, and the transmission member 86 is urged upward by the urging spring 88.

In this present embodiment, the plug portion 27 of the present invention is composed of the central pillar 12, the intermediate member 15, the hard ball 82, the transmission member 86 and others. The plug portion 27 is projected from the base plate 2 so as to be inserted into the positioning hole 5. Then, the tapered fitting surface, which is the outer peripheral surface of the intermediate member 15, forms an outer peripheral surface of the plug portion 27, which is a fitting surface allowed to come into close contact with the inner peripheral surface of the positioning hole 5.

Inside the reference block 9 is provided a lock means and a release means. The lock means thereamong is composed of both the piston 22 and an urging spring 34 arranged on the upper side of the piston 22. In the present embodiment, the urging spring 34 is composed of a plurality of coned disc spring laminated. The release means thereamong is composed of both the piston 22 and an hydraulic chamber 35 provided for releasing formed on the lower side of the piston 22.

It is noted that an air port 39 is provided on the lower surface of the reference block 9, and a relay opening 41 is provided on the outer peripheral surface of the central pillar 12. Then, the air port 39 is communicatively connected to the relay opening 41 via an air passage 40 formed inside the reference block 9. And, the jet hole 38 is formed in the intermediate member 15 in such a way that it penetrates radially through the intermediate member 15, namely, one end is opened in the tapered outer surface 13 of the intermediate member 15 and the other end is opened in the inner peripheral surface of intermediate member 15 respectively, and the other end faces the relay opening 41.

In the above-mentioned clamping apparatus, in the locked state illustrated in FIG. 7(a) and FIG. 7(b), the work pallet 3 is restricted (clamped) horizontally by the central pillar 12 via the intermediate member 15 contracted by the tapered inner surface 17 of the positioning hole 5 and also restricted (clamped) vertically by the support surface 9a. As mentioned above, the work pallet 3 can be strongly and accurately positioned and fixed to the base plate 2.

Then, in the locked state, when compressed air is supplied to the air port 39, in a case that the tapered fitting surface 16 comes into close contact with the tapered inner surface 17 and the jet hole 38 is closed, the pressure at the air port 39 increases, meanwhile, in a case that a gap is left for some reason between the tapered fitting surface 16 and the tapered inner surface 17 (that is, in a case of an abnormal clamping), the pressure at the air port 39 does not increase due to air leakage from the jet hole 38. Therefore, by checking the pressure on the air port 39 side using a pressure sensor, it is possible to detect whether a proper clamping is performed or not.

To switch the state of the clamping apparatus from the locked state illustrated in FIG. 7 into the released state, pressurized oil is supplied to the hydraulic chamber 35 provided for releasing. By supplying the pressurized oil, the piston rod 23 ascends via the piston 22, by which the hard balls 82 face the evacuating groove 84 and the hard balls are allowed to move inward. In addition, the piston rod 23 presses a ceiling wall 91 of the fixing hole 80 upwardly via the transmission member 86, thereby the work pallet 3 is pressed upward. As a result, the work pallet 3 can be detached from the base plate 2.

The coned disc spring 25 which urges the intermediate member 15 upward may be provided in one instead of provided in plurality in a laminated manner, and may be substituted with another type of spring such as a coil spring or with rubber. Further, a piston which drives the intermediate member 15 upward by air pressure or hydraulic pressure may be employed as an advancing means instead of the coned disc spring 25.

In the fifth embodiment, the jet hole 38 is provided in one, however, the jet holes may be provided in plurality. Substantially the same as the second embodiment (FIG. 3(b)) where the communication groove 42 is provided, the structure of the fifth embodiment may be constituted in such a way that the communication groove is provided as a passage in the outer peripheral surface of the central pillar 12 or in the inner peripheral surface of the intermediate member 15, and an opening end which each of the jet holes 38 forms on the inner peripheral surface of the intermediate member 15 faces the communication groove.

### Sixth Embodiment

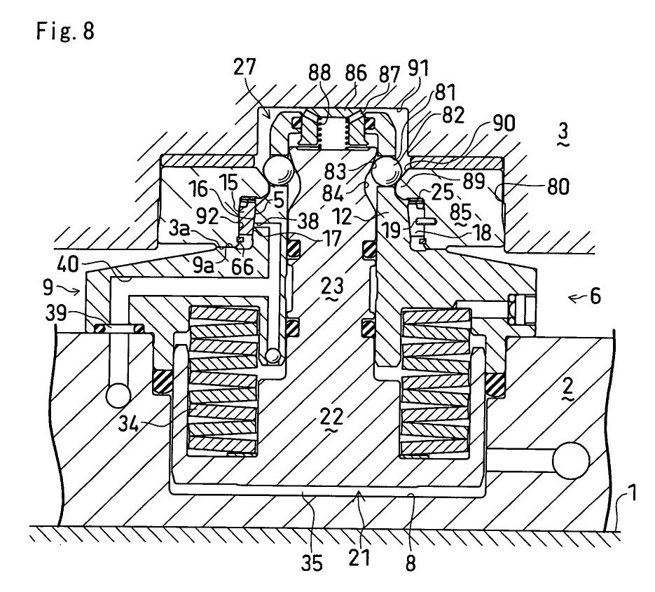

An explanation is made for the sixth embodiment by referring to FIG. 8. FIG. 8 is an elevated cross-sectional view showing a locked state of the clamp apparatus according to the sixth embodiment of the present invention and similar to FIG. 7(a).

The sixth embodiment is equivalent to an exemplified variation of the fifth embodiment and different from the fifth embodiment in the following points. That is, as illustrated in FIG. 8, the intermediate member 15 is not supported by the central pillar 12 but is supported by a support hole 92 opened in the positioning ring 85 vertically movably. The same as the fifth embodiment, the intermediate member 15 is formed in a collet shape having the slit 18, but the intermediate member 15 is provided with a straight surface on its outer peripheral surface and provided with a tapered inner surface (inclined inner surface) 17 on its inner peripheral surface. The inner peripheral surface of the support hole 92 of the positioning ring 85 is formed into a straight surface, and the outer peripheral surface of the intermediate member 15 is supported on the inner peripheral surface of the support hole 92. In the present embodiment, the tapered inner surface 17, which is the inner peripheral surface of the intermediate member 15, corresponds to the inner peripheral surface of the positioning hole 5.

The outer peripheral surface of the central pillar 12 projected from the reference block 9 is not formed into a straight surface, but formed into a tapered fitting surface 16. The tapered inner surface 17, which is the inner peripheral surface of the intermediate member 15, is allowed to make a tapering engagement with the tapered fitting surface 16. A coned disc spring 25 is placed as an advancing means on the ceiling surface of the support hole 92 of the positioning ring 85, and the coned disc spring 25 urges the intermediate member 15 downward (namely, in such a direction to tighten the tapering engagement between the tapered fitting surface 16 and the tapered inner surface 17). A retaining ring 66 is fitted to a lower end portion of the support hole 92 to receive a lower end portion of the intermediate member 15, thereby the lower end of the vertical stroke of the intermediate member 15 is provided.

One end of the air passage 40 connected to the air port 39 is opened in the outer peripheral surface of the central pillar 12, namely, the tapered fitting surface 16.

In this embodiment, the plug portion 27 of the present invention is composed of the central pillar 12, the hard balls 82, the transmission member 86 and others. The plug portion 27 is projected from the base plate 2 so as to be inserted into the positioning hole 5. Then, the tapered fitting surface 16, which is the outer peripheral surface of the central pillar 12, forms an outer peripheral surface of the plug portion 27, which is an fitting surface allowed to come into close contact with the inner peripheral surface of the positioning hole 5.

In the above mentioned clamping apparatus, when compressed air is supplied to the air port 39 in the locked state illustrated in FIG. 8, in a case that the tapered fitting surface 16 has come into close contact with the tapered inner surface 17 and the jet hole 38 is closed, the pressure at the air port 39 increases, meanwhile, in a case that a gap is left for some reason between the tapered fitting surface 16 and the tapered inner surface 17 (that is, in a case of an abnormal clamping), the pressure at the air port 39 does not increase due to air leakage from the jet hole 38. Therefore, by checking the pressure on the air port 39 side using a pressure sensor, it is possible to detect whether a proper clamping is performed or not.

To switch the state of the clamping apparatus from the locked state illustrated in FIG. 8 into the released state, pressurized oil is supplied to the hydraulic chamber 35 provided for releasing. By supplying the pressurized oil, the piston rod 23 ascends via the piston 22, by which the hard balls 82 face the evacuating groove 84 and the hard balls are allowed to move inward. In addition, the piston rod 23 presses the ceiling wall 91 of the fixing hole 80 upwardly via the transmission member 86, thereby the work pallet 3 is pressed upward. As a result, the work pallet 3 can be detached from the base plate 2.

In the sixth embodiment, the jet hole 38 is provided in one, however, the jet holes may be provided in plurality. In this instance, the air passage 40 is branched so as to be connected to each of the jet holes 38.

Six preferred embodiments of the present invention have been so far described, but the present invention is not restricted thereto. It is apparent that various embodiments may be made without departing from the spirit and scope of the present invention.

What is claimed is:

1. A clamping apparatus, wherein
a central pillar (12) is projected from a reference member (2) so as to be inserted into a hole (5) opened in a movable member (3),
the central pillar (12) is provided with an inclined outer surface (13) that gets closer to the axis toward a leading end of the projecting direction,
an annular intermediate member (15) in which at least a part of the circumferential direction is allowed to deform in both the expanding direction and contracting direction is arranged at the outside of the inclined outer surface (13), the intermediate member (15) is provided with a straight outer surface (16) allowed to fit to an inner peripheral surface of the hole (5) and with an inclined inner surface (17) facing the inclined outer surface (13),
a pull member (21) is inserted into the central pillar (12) axially movably, and the pull member (21) is connected to the intermediate member (15),
a lock means and a release means are provided in the reference member (2), the lock means moves the intermediate member (15) via the pull member (21) toward a base end for locking and-the release means moves the intermediate member (15) via the pull member (21) toward the leading end for releasing,
a fluid flow hole (38) is opened in the straight outer surface (16) of the intermediate member (15), and when the intermediate member (15) moves for locking and the straight outer surface (16) comes into close contact with the inner peripheral surface of the hole (5), the fluid flow hole (38) is closed by the inner peripheral surface of the hole (5).

2. A clamping apparatus, wherein
a central pillar (12) is projected from a reference member (2) so as to be inserted into a hole (5) opened in a movable member (3),
the central pillar (12) is provided with an inclined outer surface (13) that gets closer to the axis toward a leading end of the projection direction,
a plurality of pressing members (43) that are radially movable are arranged at the outside of the inclined outer surface (13), and the pressing member (43) is provided with a straight outer surface (16) allowed to fit to an inner peripheral surface of the hole (5) and with an inclined inner surface (17) facing the inclined outer surface (13),
a pull member (21) is inserted into the central pillar (12) axially movably, and the pull member (21) is connected to the pressing members (43),
a lock means and a release means are provided in the reference member (2), the lock means moves the pressing members (43) via the pull member (21) toward a base end for locking, and the release means moves the pressing members (43) via the pull member (21) toward the leading end for releasing,
a fluid flow hole (38) is opened in the straight outer surface (16) of the pressing member (43), and when the pressing member (43) moves for locking and the straight outer surface (16) comes into close contact with the inner peripheral surface of the hole (5), the fluid flow hole (38) is closed by the inner peripheral surface of the hole (5).

3. A clamping apparatus, wherein
a central pillar (12) is projected from a reference member (2) so as to be inserted into a hole (5) opened in a movable member (3),
an inner sleeve (61) which is radially expandable and contractible is supported on the central pillar (12) movably along the axis of the central pillar (12), and a tapered outer surface (13) is formed on an outer peripheral surface of the inner sleeve (61),
an outer sleeve (71) which is radially expandable and contractible is arranged at the outside of the inner sleeve (61), a tapered inner surface (17) allowed to make a tapering engagement with the tapered outer surface (13) is formed on an inner peripheral surface of the outer sleeve (71), a straight surface (16) allowed to fit to an inner peripheral surface of the hole (5) is formed on an outer peripheral surface of the outer sleeve (71),
an advancing means (25) which presses the inner sleeve (61) in such a direction as to tighten the tapering engagement is provided,
a fluid flow hole (38) is opened in the straight outer surface (16), and when the straight outer surface (16) comes into close contact with the inner peripheral surface of the hole (5), the fluid flow hole (38) is closed by the inner peripheral surface of the hole (5).

4. A clamping apparatus, wherein
a central pillar (12) is projected from a reference member (2) so as to be inserted into a hole (5) opened in a movable member (3),
an intermediate member (15) which is radially expandable and contractible is supported on the central pillar (12) movably along the axis of the central pillar (12),
a tapered fitting surface (16) is formed on an outer peripheral surface of the intermediate member (15), a tapered inner surface (17) allowed to make a tapering engagement with the tapered fitting surface (16) is formed on the hole (5),
an advancing means (25) which presses the intermediate member (15) in such a direction as to tighten the tapering engagement is provided, and
a fluid flow hole (38) is opened in the tapered fitting surface (16), and when the tapered fitting surface (16) comes into close contact with the tapered inner surface (17), the fluid flow hole (38) is closed by the tapered inner surface (17).

5. A clamping apparatus, wherein
a central pillar (12) is projected from a reference member (2) so as to be inserted into a hole (5) opened in a movable member (3),
an intermediate member (15) which is radially expandable and contractible is supported on a support hole (92) of the movable member (3) movably along the axis of the support hole (92),
a tapered inner surface (17) constituting the hole (5) is formed on an inner peripheral surface of the intermediate member (15), and a tapered fitting surface (16) allowed to make a tapering engagement with the tapered inner surface (17) is formed on the central pillar (12),
an advancing means (25) which presses the intermediate member (15) in such a direction as to tighten the tapering engagement is provided, and
a fluid flow hole (38) is opened in the tapered fitting surface (16), and when the tapered fitting surface (16) comes into close contact with the tapered inner surface (17), the fluid flow hole (38) is closed by the tapered inner surface (17).

6. A clamping apparatus as set forth in any one of claim 1 through claim 5, wherein
the fluid flow holes (38) are provided in plurality.

7. A clamping apparatus as set forth in claim 6, wherein
the fluid flow holes (38) are provided circumferentially in plurality.

8. A clamping apparatus as set forth in claim 1 or claim 2, wherein
a housing (9) provided in the reference member (2) is provided with a fluid port (39) for supplying pressurized fluid or discharging fluid,
a fluid passage (40) is provided inside the housing (9) and the fluid passage (40) is connected to the fluid port (39),
the fluid passage (40) is provided with a relay opening (41) in the inclined outer surface (13) of the central pillar (12), and
the fluid flow hole (38) is provided so that one end is opened in the straight outer surface (16) and the other end is opened in the inclined inner surface (17) respectively, and the other end faces the relay opening (41).

9. A clamping apparatus as set forth in claim 8, wherein
the fluid flow holes (38) are provided circumferentially in plurality,
the fluid passage (40) is communicatively connected to a groove (42) formed in the circumferential direction in at least either the inclined outer surface (13) of the central pillar (12) or the inclined inner surface (17) of the intermediate member (15), and
each of the openings of the fluid flow holes (38) on the inclined inner surface (17) side faces the groove (42).

10. A clamping apparatus as set forth in claim 3, wherein
a housing (9) provided in the reference member (2) is provided with a fluid port (39) for supplying pressurized fluid or discharging fluid,
a fluid passage (40) is provided inside the housing (9), and the fluid passage (40) is connected to the fluid port (39),
the fluid passage (40) is provided with a relay opening (41) in an outer peripheral surface of the central pillar (12), and
the fluid flow hole (38) is provided so that one end is opened in the straight outer surface (16) and the other end is opened in the tapered inner surface (17) respectively, and the other end is connected to the relay opening (41) via a communication hole (79) formed in the inner sleeve (61) in a penetrating manner.

11. A clamping apparatus as set forth in claim 10, wherein
the fluid flow holes (38) are provided circumferentially in plurality,
the fluid passage (40) is communicatively connected to a groove formed in the circumferential direction in at least either the inclined outer surface (13) of the inner sleeve (61) or the inclined inner surface (17) of the outer sleeve (71), and
each of the openings of the fluid flow holes (38) on the inclined inner surface (17) side faces the groove.

12. A clamping apparatus as set forth in claim 4, wherein
a housing (9) provided in the reference member (2) is provided with a fluid port (39) for supplying pressurized fluid or discharging fluid,
a fluid passage (40) is provided inside the housing (9), and the fluid passage (40) is connected to the fluid port (39),
the fluid passage (40) is provided with a relay opening (41) in an outer peripheral surface of the central pillar (12),
the fluid flow hole (38) is provided so that one end is opened in the tapered fitting surface (16) and the other end is opened in an inner peripheral surface of the intermediate member (15) respectively, and the other end faces the relay opening (41).

13. A clamping apparatus as set forth in claim 12, wherein
the fluid flow holes (38) are provided circumferentially in plurality,
the fluid passage (40) is communicatively connected to a groove formed in the circumferential direction in at least either the inner peripheral surface of the intermediate member (15) or the outer peripheral surface of the central pillar (12), and
each of the openings of the fluid flow hole (38) on the inner peripheral surface side of the intermediate member (15) faces the groove.

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)
